(19) United States
(12) Patent Application Publication
(10) Pub. No.: US 2007/0158322 A1
(43) Pub. Date: Jul. 12, 2007

(54) Device and method for transporting a welding rod

(76) Inventors: Walter Stieglbauer, Manning (AT); Wolf Kronegger, Vorchdorf (AT)

Correspondence Address: WILLIAM COLLARD;COLLARD & ROE, P.C., 1077 NORTHERN BOULEVARD, ROSLYN, NY, 11576, US

(21) Appl. No.: 10/587,152

(22) PCT Filed: Jan. 27, 2005
(86) PCT No.: PCT/AT05/00022

§ 371 Date: Jul. 25, 2006

(30) Foreign Application Priority Data
Jan. 27, 2004 (AT) A 103/2004

(51) Int. Cl. B23K 9/28

(52) U.S. Cl. 219/137.2

(57) ABSTRACT

The invention relates to a rod transporting device for transporting a welding rod (13) from a rod supply to a point of consumption, and to a method for transporting a welding rod (13). The aim of the invention is to provide a device or a method of the aforementioned kind which can be produced at low costs and carried out easily, respectively, and which allow for a reverse movement of the rod can at rapid reaction times and for an automatic adaptation to welding rods (13) having different diameters. For this purpose, at least one transport element (33) is linked with a drive (37) and at least one additional transport element (33) with the welding rod (13) in a non-positive and/or positive manner, and at least one element (28) for adaptation to the diameter of the welding rod is mounted so as to be displaceable. The transport elements are preferably configured as balls and the drive is a drive sleeve in which the elements are centered and engage with a threaded section of the drive sleeve.

The invention relates to a wire feed device for transporting a welding wire from a wire storage to a point of consumption, including at least one element for guiding the welding wire, wherein at least one element including a guide path is provided, along which several transport elements are displaceably mounted.

The invention further relates to a method for feeding a welding wire from a wire storage to a point of consumption, wherein the welding wire is guided through at least one element, and wherein several transport elements are guided in at least one element to circulate along a guide path, with at least one transport element being in operative connection with the welding wire on a side of the element facing the welding wire.

In the systems known from the prior art, different wire feed devices or drives are used, which are, for instance, subject to a high slip and wear and, in addition, have large dimensions and, moreover, deform the welding wire. Those wire feed devices are only difficult to incorporate in hand torches, since, due to their relatively large dimensions, also the hand torch would have to be designed in an accordingly large manner. This would render the guidance and handling of the hand torch difficult and substantially more cumbersome for the user. It is, therefore, required to arrange the wire feed device outside of the hand torch, whereby, however, the advantages of a wire feed located as close to the place of welding as possible will be lost.

Also known are wire feed devices, in particular planetary drives, which are designed in a more compact manner, yet feature very high speeds, whereby, for instance, at a reversal of the wire feed direction, braking of the motor will take a long time so as to cause a very large slack, thus rendering the same very sluggish. Therefore, an installation of such wire feed devices in hand torches is feasible, yet virtually without enabling a reversing wire feed. In addition, that planetary drive involves the drawback of requiring exchanges of the transport element, the whole drive, or the feed rollers, for different welding wire diameters, such a feed roller exchange being, however, very cumbersome because of small pressure elements such as, for instance, compression springs.

SU 1 088 898 A discloses a device for feeding a welding wire, by which spherically shaped transport elements are pressed on the wire to be fed. The transport elements are moved in the longitudinal direction by the rotation of a spiral spring, thus causing the welding wire to likewise move in the longitudinal direction. Via a guide path provided in the housing of the device, the transport balls are moved back again. The dimensions of the device are adjusted to a particular wire diameter, and therefore an adaptation to welding wires having different diameters is feasible not at all or only with great efforts.

SU 1 082 577 A discloses a device for feeding a welding wire, which uses balls running in rotating sleeves to transport the welding wire. Also that construction merely allows the transport of welding wires having particular wire diameters.

SU 846 160 B discloses another variant of a wire feed device, in which flexible elements are set in rotation to transport the welding wire in the desired direction by pressing on the same. The construction is characterized by a particularly low pressure force, which enables also soft welding wires, for instance of aluminum, to be transported in an optimum manner. The low pressing pressure, however, causes a large slip.

The object of the present invention, therefore, resides in providing a wire feed device exhibiting a small and compact mode of construction and, at the same time, little wear and, hence, little maintenance and low costs. Another object resides in realizing a reversing movement at reaction times as short as possible.

An object of the invention also consists in providing an automatic adaptation to different welding wires or welding wire diameters, respectively.

A further object of the invention consists in providing an above-mentioned method for feeding a welding wire, which is cost-effective to perform and allows for reversing movements at reaction times as short as possible as well as the automatic adaptation to different welding wires or welding wire diameters, respectively.

The objects of the invention are achieved in that at least one transport element is connected with a drive means and at least one further transport element is connected with the welding wire in a force-locking and/or form-locking manner, and that at least one element is displaceably arranged for adaptation to the diameter of the welding wire. The advantage resides in that, in the wire feed device according to the invention, the transport elements, in particular balls, are guided in the element or cage in a manner similar to a ball bearing, whereby the friction is considerably reduced, since the contact area of a ball is substantially smaller than with other, conventional systems or shapes. The element for guiding the welding wire is able to either simultaneously drive, or just guide, the welding wire. To adapt the wire feed device to welding wires having different diameters, at least one element is accordingly movably arranged. This element may be an element driving the welding wire or just guiding the welding-wire. Hence, no structural components necessary for the welding wire feed need be exchanged in the event of different welding wire materials and welding wire diameters. The automatic adaptation to the most different welding wires is hence feasible with a constant pressing pressure being exerted on the welding wire by the transport elements all the time. Moreover, the wire feed device excels by a particularly rapid response, since little or no slack at all of the transport elements inserted in the element or cage takes place at a reversal of direction. The slack as well as the reaction time for the reversal of the feed direction are merely influenced by the electromotor coupled with the wire feed device. Another advantage consists in that very simple coupling to the drive or motor is feasible.

By a configuration according to claim 2, at least one element is displaceably arranged in a base body. This constitutes a simple realization of the displaceable arrangement of the element.

By a configuration according to claims 3 and 4, the elements can be arranged around the welding wire and, hence towards the welding wire, i.e., about periphery of the welding wire, thus optimally pressing or acting on the welding wire. By these arrangements, several pressure points can be formed on the welding wire so as to ensure safe feeding. If several transport elements of an element act on the welding wire, the number of pressure points will increase proportionally to the number of elements.

By the configuration according to claim 5, the dimensions of the wire feed device according to the invention can be substantially reduced so as to obtain a small and compact mode of construction. At the same time, a very simple and cost-effective drive means is provided for the transport elements.

A configuration according to claim 6 is, however, also advantageous, since thereby only slight friction losses caused, for instance, by edges and/or pressure surfaces will occur.

The configuration according to claim 7 provides simple positioning of the individual parts relative to one another.

A configuration according to claims 8 to 11 offers the advantage that the drive sleeve is thereby rotationally mounted on the base body and, hence, provides simple mounting requiring little space. It also enables, for instance, a ball bearing to be used in the region of the projection so as to substantially reduce friction losses.

A configuration according to claim 12 is advantageous, because it allows the use of a simple drive or motor known from the prior art.

Due to the characteristic features according to claims 13 to 15, a simple a compact structure of the wire feed device can be provided.

The configuration according to claim 16 allows for simple adjustment to different welding wires and, in particular, welding wire materials and thicknesses.

Also of advantage is the configuration according to claim 17, since it provides a simple guide for the element or cage with the transport elements arranged therein, such that it will be displaced in the longitudinal direction so as to enable the automatic adjustment to different welding wires and welding wire thicknesses.

A configuration according to claim 18 offers the advantage of enabling the use of a simple and cost-effective design of the transport element and, hence, a frictionless conveyance of the transport element.

Also advantageous is, however, a configuration according to claim 19, since it provides a small and compact mode of construction of the wire feed device and, hence, enables its use in a hand torch.

Yet, a configuration according to claim 20 is also of advantage, since it enables the wire feed device to be integrated in a welding plant on the strategically most important points for the wire feed, without substantially affecting the structural size of the welding plant.

The object of the invention is also achieved by a method of the initially defined kind according to claims 21 to 40, with the advantages resulting therefrom being apparent from the description and the previously described claims 1 to 20.

The present invention will be explained in more detail by way of the attached drawings. Therein:

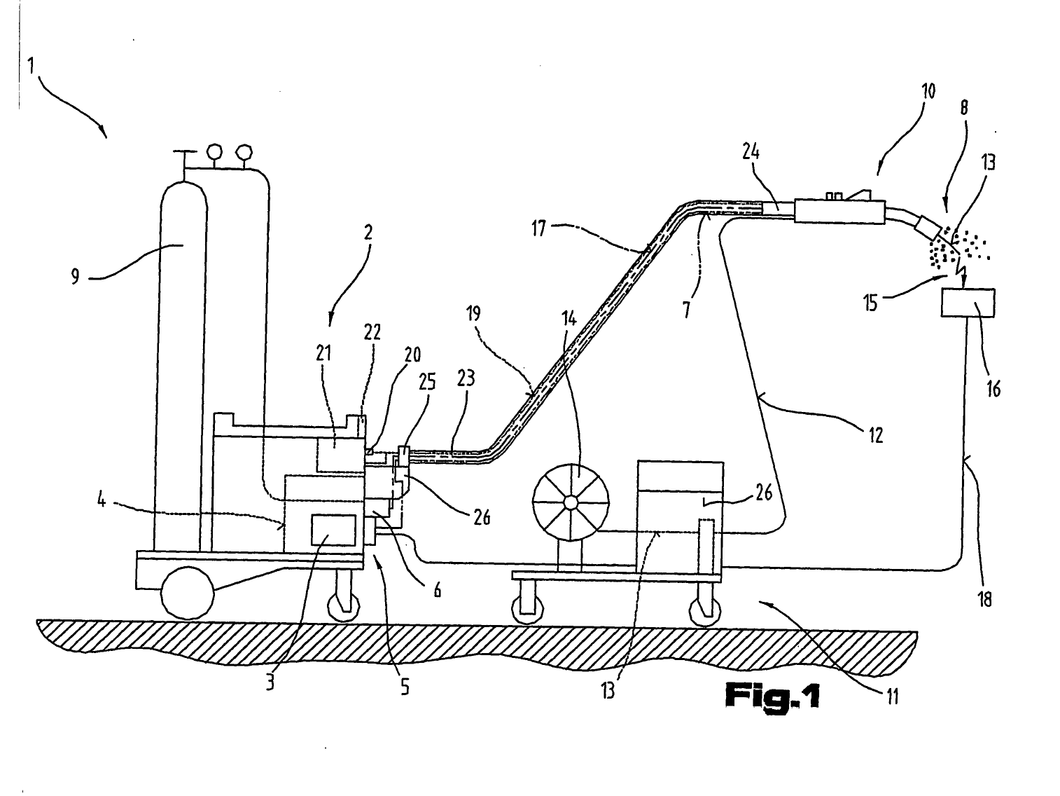

FIG. 1 is a schematic illustration of a welding apparatus;

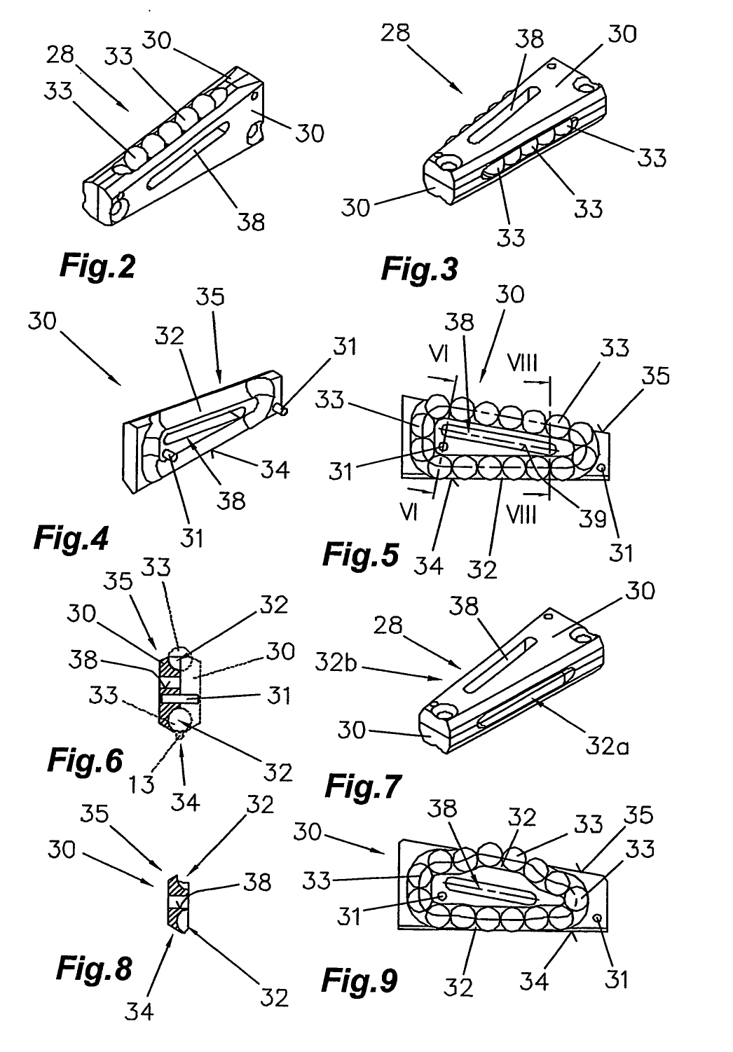

FIGS. 2 and 3 are perspective, schematic illustrations of an element according to the invention for guiding the welding wire;

FIG. 4 is a perspective view of a half-shell of the element;

FIG. 5 is a top view on the half-shell according to FIG. 4 with transport elements drawn in;

FIG. 6 is a sectional view taken along the sectional line VI-VI of FIG. 5;

FIG. 7 is a perspective, schematic illustration of an element containing no transport elements;

FIG. 8 is a sectional view taken along the sectional line VIII-VIII of FIG. 5;

FIG. 9 is a view of a half-shell containing transport elements and a modified guide path;

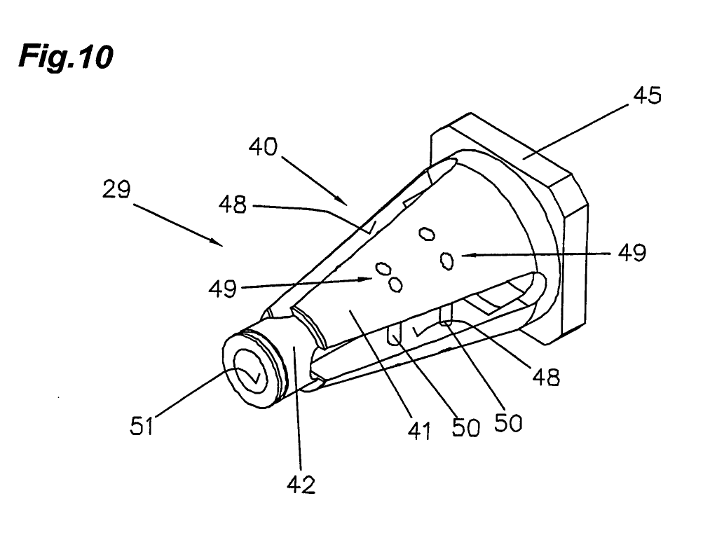

FIG. 10 is a perspective, schematic illustration of a base body of the device according to the invention;

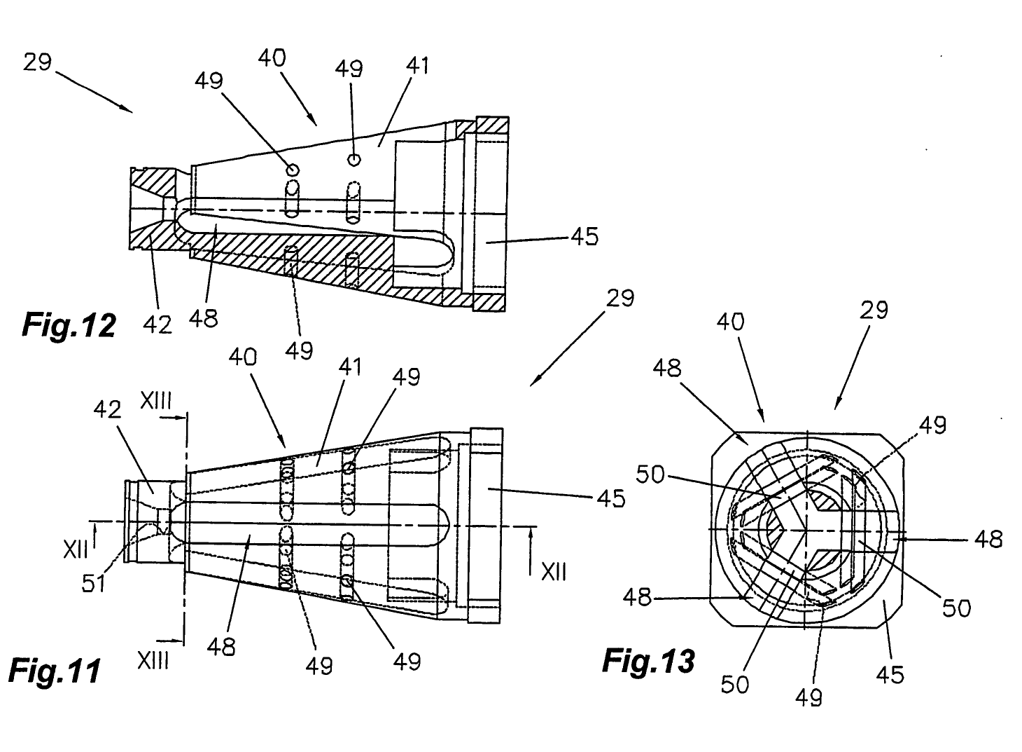

FIG. 11 is a two-dimensional, schematic illustration of the base body;

FIG. 12 is a sectional view taken along the sectional line XII-XII of FIG. 11;

FIG. 13 is a top view on the base body according to FIG. 10;

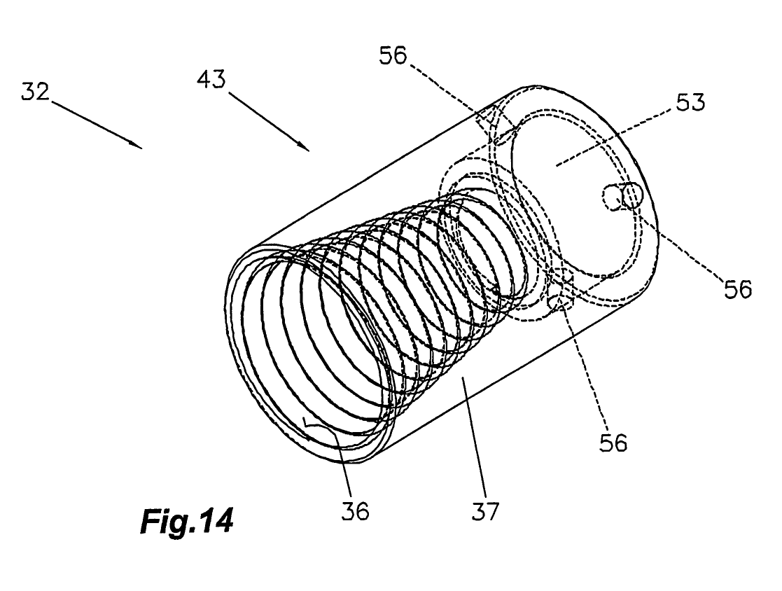

FIG. 14 is a perspective, schematic illustration of a drive means;

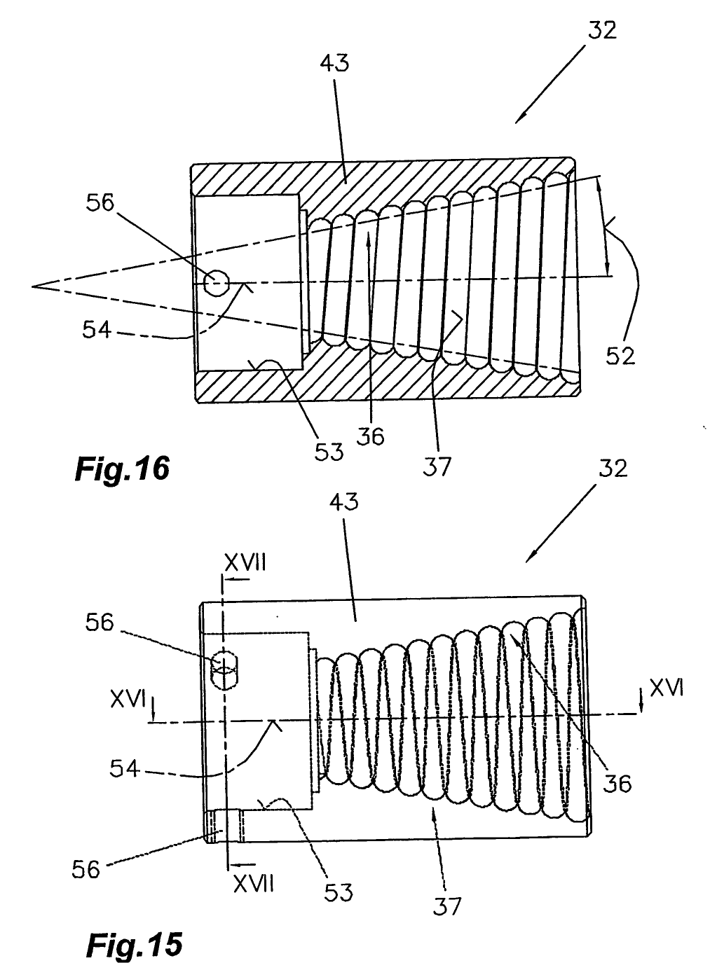

FIG. 15 is a schematic illustration of the drive means;

FIG. 16 is a sectional view taken along the sectional line XVI-XVI of FIG. 15;

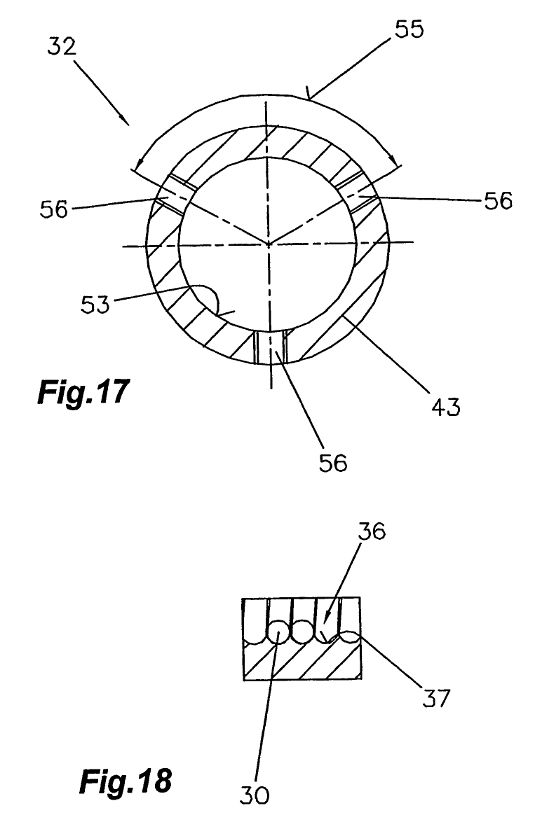

FIG. 17 is a sectional view taken along the sectional line XVII-XVII of FIG. 15;

FIG. 18 shows a detail of the thread of the drive means;

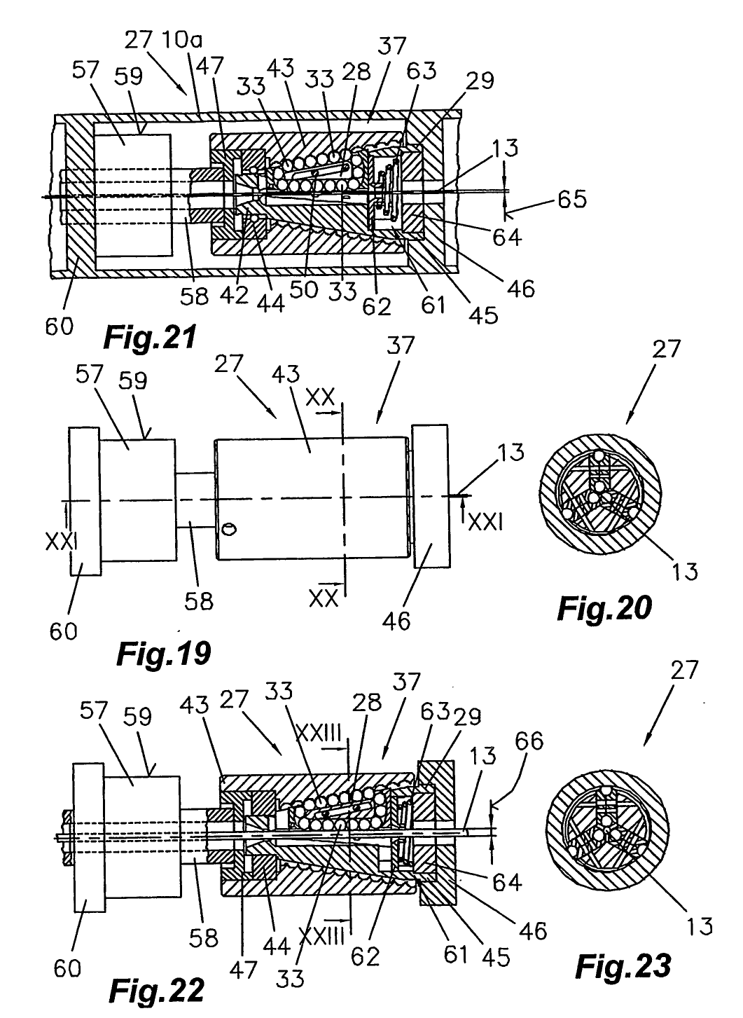

FIG. 19 is a schematic illustration of the assembled wire feed device;

FIG. 20 is a top view on the wire feed device;

FIG. 21 is a sectional view taken along the sectional line XXI-XXI of FIG. 19;

FIG. 22 is a sectional view taken along the sectional line XXI-XXI of FIG. 19, with a modified, enlarged welding wire diameter in respect to FIG. 21;

FIG. 23 is a top view on the wire feed device according to FIG. 22;

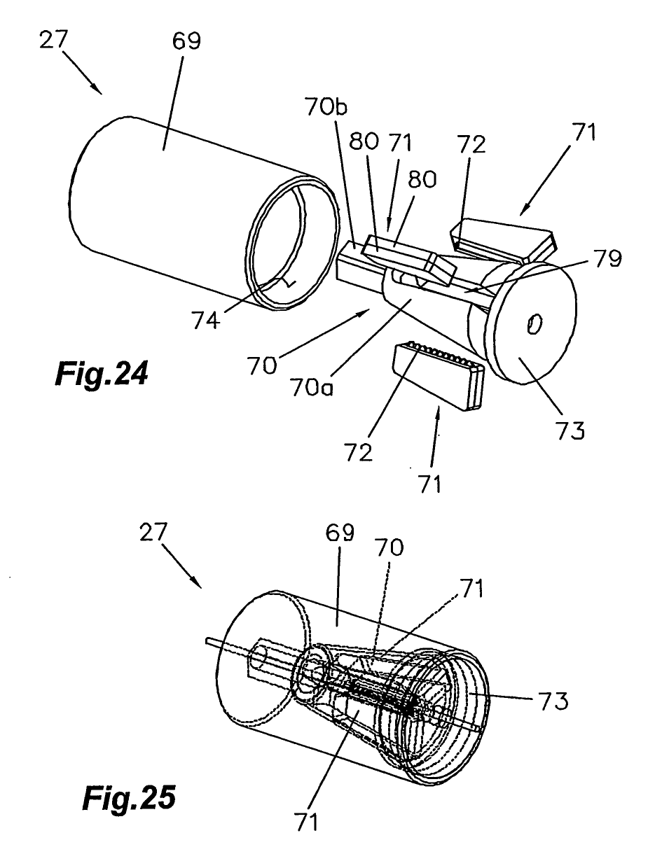

FIG. 24 is a perspective, schematic explosion view of a further embodiment of the wire feed device;

FIG. 25 is a perspective, schematic explosion view of the wire feed device in the assembled state;

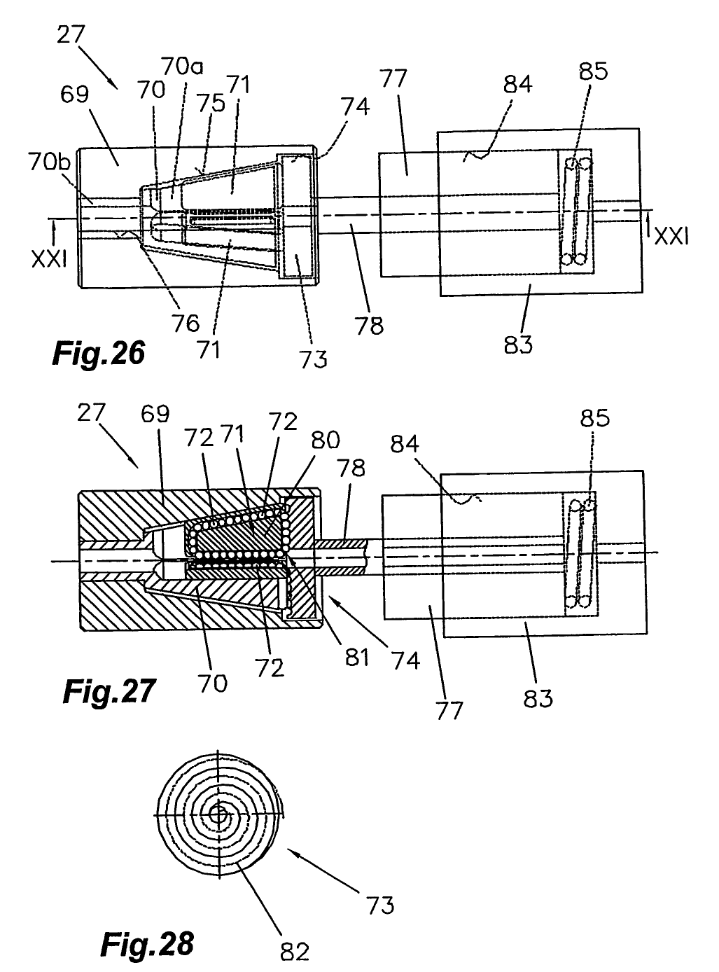

FIG. 26 is a two-dimensional, schematic illustration of the wire feed device including a drive;

FIG. 27 is a sectional view taken along the sectional line XXVII-XXVII of FIG. 26;

FIG. 28 is a schematic illustration of a drive pulley;

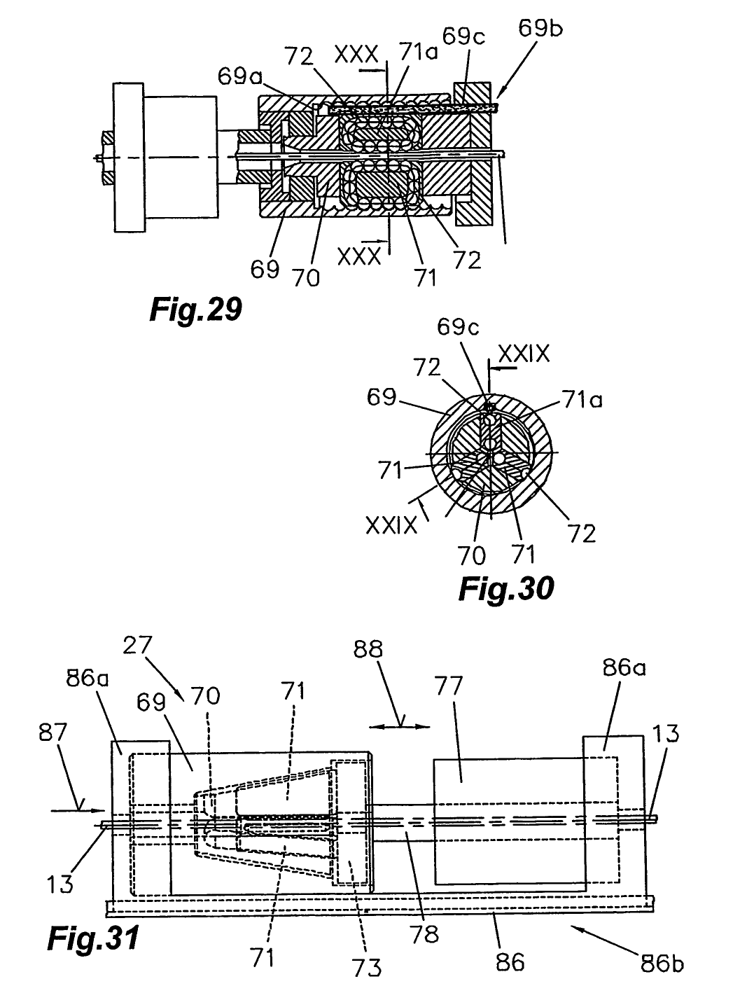

FIG. 29 is a partially sectioned, schematic illustration of a further embodiment of a wire feed device;

FIG. 30 is a sectional view taken along the sectional line XXX-XXX of FIG. 29;

FIG. 31 is a schematic illustration of the further variant embodiment of the wire feed device;

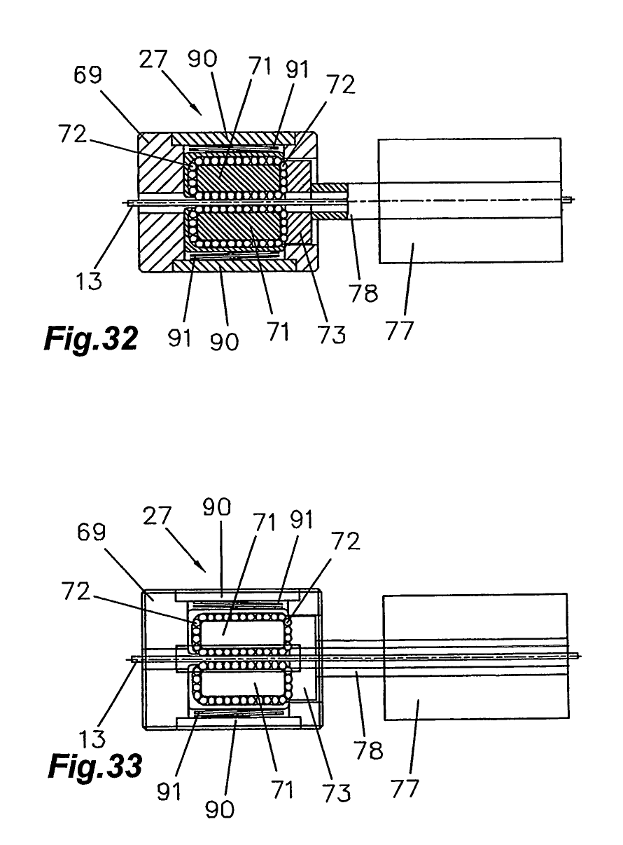

FIG. 32 depicts a further variant embodiment of the wire feed device in a partially sectioned illustration;

FIG. 33 shows the wire feed device in the assembled and non-sectioned state;

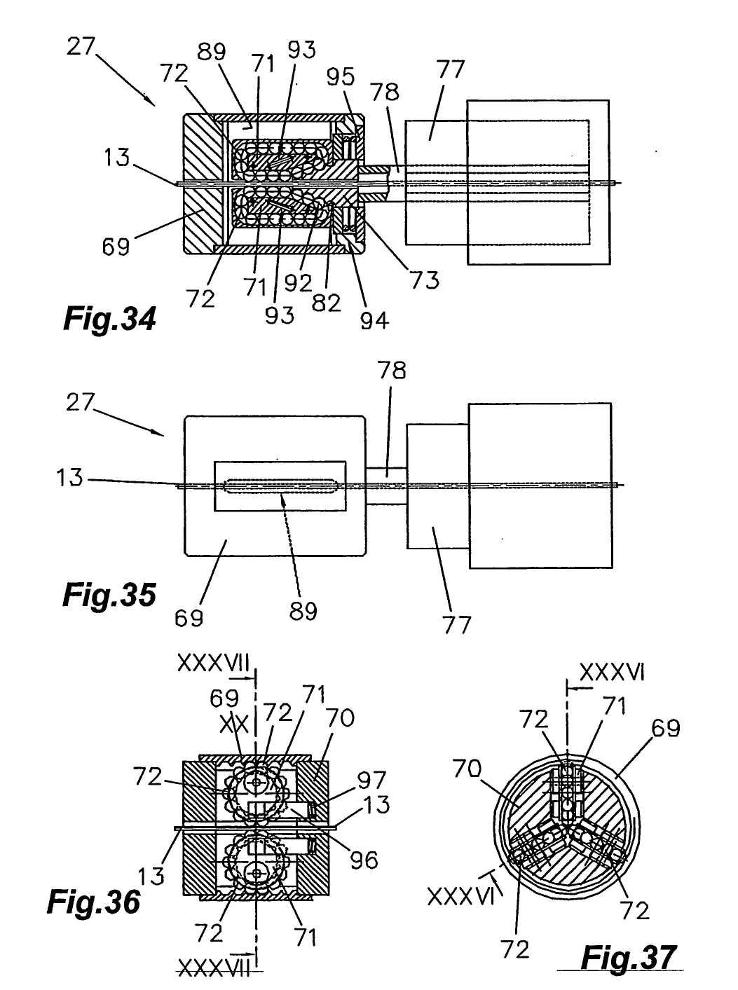

FIG. 34 depicts a further variant embodiment of the wire feed device in a partially sectioned illustration;

FIG. 35 shows the wire feed device in the assembled and non-sectioned state;

FIG. 36 is a sectional view of the wire feed device according to FIG. 37 taken along sectional line XXXVI-XXXVI;

FIG. 37 is a sectional view of the wire feed device according to FIG. 36 taken along sectional line XXXVII-XXXVII;

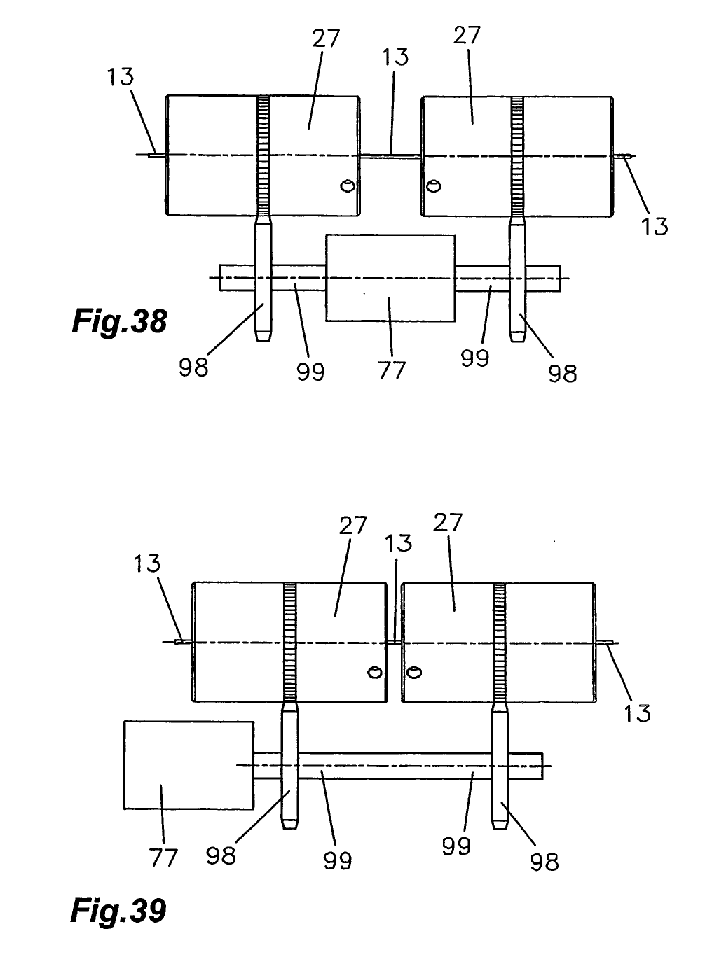

FIG. 38 is a schematic illustration of the wire feed device with a drive arranged laterally or below the wire feed device;

FIG. 39 is a further schematic illustration of the wire feed device with a drive arranged laterally or below the wire feed device;

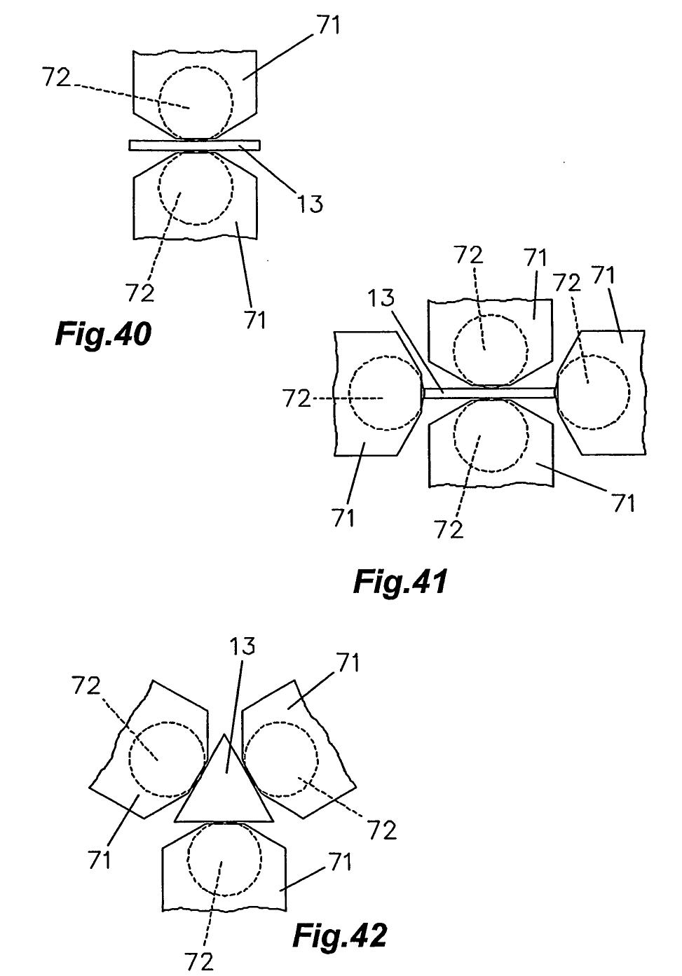

FIG. 40 shows a detail of the wire feed device according to the invention including two elements acting on a flat wire;

FIG. 41 shows a further detail including four elements acting on a flat wire;

FIG. 42 shows a further detail including three elements acting on a triangular welding wire; and

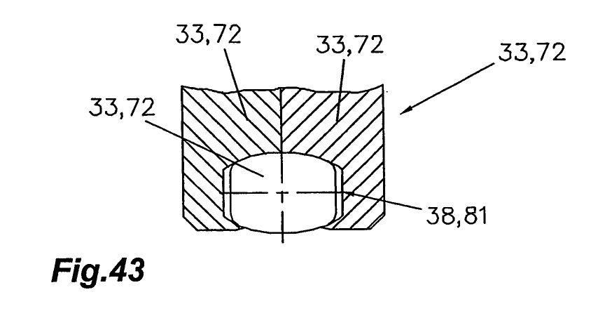

FIG. 43 is a schematic illustration of an element including an elongate-oval transport element.

FIG. 1 depicts a welding apparatus 1, or welding system, for various processes or methods such as, e.g., MIG/MAG welding or WIG/TIG welding, or electrode welding methods, double-wire/tandem welding methods, plasma or soldering methods etc.

The welding apparatus 1 comprises a power source 2 including a power element 3, a control device 4, and a switch member 5 associated with the power element 3 and control device 4, respectively. The switch member 5 and the control device 4 are connected to a control valve 6 arranged in a feed line 7 for a gas 8, in particular a protective gas such as, for instance, carbon dioxide, helium or argon and the like, between a gas reservoir 9 and a welding torch 10 or torch.

In addition, a wire feeder 11, which is usually employed in MIG/MAG welding, can be controlled by the control device 4, whereby a filler material or welding wire 13 is fed from a feed drum 14 or wire coil into the region of the welding torch 10 via a feed line 12. It is, of course, possible to integrate the wire feeder 11 in the welding apparatus 1 and, in particular, its basic housing, as is known from the prior art, rather than designing the same as an accessory device as illustrated in FIG. 1.

It is also feasible for the wire feeder 11 to supply the welding wire 13, or filler metal, to the process site outside the welding torch 10, to which end a non-consumable electrode is preferably arranged within the welding torch 10, as is usually the case with WIG/TIG welding.

The power required to build up an electric arc 15, in particular an operative electric arc, between the electrode or welding wire 13, respectively, and a workpiece 16 is supplied from the power element 3 of the power source 2 to the welding torch 10, in particular electrode, via a welding line 17, wherein the workpiece 16 to be welded, which is preferably formed by several parts, via a further welding line 18 is likewise connected with the welding apparatus 1 and, in particular, power source 2 so as to enable a power circuit for a process to build up over the electric arc 15, or a plasma jet formed.

To provide cooling of the welding torch 10, the welding torch 10 can be connected to a fluid reservoir, in particular a water reservoir 21, by a cooling circuit 19, for instance, via an interposed flow control 20, so as to cause the cooling circuit 19, in particular a fluid pump used for the fluid contained in the water reservoir 21, to be started as the welding torch 10 is put into operation, in order to effect cooling of the welding torch 10 by feeding a cooling medium.

The welding apparatus 1 further comprises an input and/or output device 22, via which the most different welding parameters, operating modes or welding programs of the welding apparatus 1 can be set and called, respectively. In doing so, the welding parameters, operating modes or welding programs set via the input and/or output device 22 are transmitted to the control device 4, which subsequently controls the individual components of the welding system or welding apparatus 1 and/or predetermines the respective set values for controlling.

In the exemplary embodiment illustrated, the welding torch 10 is, furthermore, connected with the welding apparatus 1 or welding system via a hose pack 23. The hose pack 23 houses the individual lines from the welding apparatus 1 to the welding torch 10. The hose pack 23 is connected with the welding torch 10 via a coupling mechanism 24, whereas the individual lines arranged in the hose pack 23 are connected with the individual contacts of the welding apparatus 1 via connection sockets or plug-in connections. In order to ensure an appropriate strain relief of the hose pack 23, the hose pack 23 is connected with a housing 26, in particular the basic housing of the welding apparatus 1, via a strain relief means 25. It is, of course, also possible to use the coupling mechanism 24 for connection to the welding apparatus 1.

It should basically be noted that not all of the previously mentioned components have to be used or employed for the various welding methods or welding apparatus 1 such as, e.g., WIG devices or MIG/MAG apparatus or plasma devices. Thus, it is, for instance, possible to devise the welding torch 10 as an air-cooled welding torch 10.

FIGS. 2 to 43 depict various embodiments of wire feed devices 27 for transporting a welding wire 13. The wire feed device 27, for instance, feeds the welding wire 13 from a wire storage, in particular the feed drum 14, to a point of consumption, in particular the welding torch 10.

The wire feed device 27 can, for instance, be used in the welding apparatus 1 or in the welding torch 10 or as an external drive unit. It is also possible that several of such wire feed devices 27 are simultaneously used in one welding plant, or combined with other wire feed device assemblies.

FIGS. 2 to 9 especially illustrate an element 28, in particular cage, of the wire feed device 27. The element 28 is arranged in a base body 29 (cf. FIGS. 10-13 and FIGS. 19-27) so as to be preferably displaceable particularly in the longitudinal and/or vertical directions.

The element 28 is, for instance, comprised of two half-shells 30 which are positioned relative to each other via at least one fixing pin 31, as is apparent from FIG. 4. It is, of course, also possible to position the two half-shells 30 in any other fashion. It is, for instance, possible to interconnect the two half-shells 30 via a screw connection, wherein at least one additional fixing pin 31 can be used to ensure exact positioning. A peripheral guide path 32 is machined into the half-shell 30 to accommodate transport elements 33. The transport elements 33 are designed in the form of balls. They may, however, also be designed to have other configurations or contours. It should basically be noted that the guide path 32, on a side 34 of the element 28 facing the welding wire 13, is designed such that at least one transport element 33 projects partially out of the element 38 to act on the welding wire 13, as is apparent from FIG. 6, where the welding wire 13 is entered in broken lines. The contour of the guide path 32 preferably matches the contour or shape of the transport elements 33. The transport element 33, in particular ball, projects only slightly out of the element 28 and presses on the welding wire 13 with the wire feed device 27 assembled. In this respect, it is essential that the guide path 32 be designed in a manner that a groove or opening 32a is formed with the assembled half-shells 30, as is apparent from FIG. 7, in order to allow the transport elements 33 to project out of the interior of the guide path 32. The transport element 33 is, thus, protected against falling out while nevertheless sufficiently projecting out of the element 28 so as to be in operative connection with the welding wire 13.

On a side 35 located opposite the welding wire 13, of the element 28, the guide path 32 is designed such that the transport element 33 likewise projects partially out of the element 28 and, for instance, engages a thread 36 of a drive means 37, said arrangement or function being apparent from, and described in, the following FIGS. 19 to 23. On this side 35, the transport element 33 projects out almost as far as to the center of the transport element 33 in order to be able to sufficiently engage the thread 36 of the drive means 37, yet while being prevented from falling out. Thereby, a groove or opening 32b is again formed with the half-shells 30 assembled and no transport elements 33 inserted. At least one transport element 33 must engage the thread 36 of the drive means 37. By rotating the drive means 37, the respective transport element 33 engaging the thread 36 is conveyed in the peripheral guide path 32 of the element 28 or half-shells 30. The rotation of the thread 36, thus, causes a displacement of the engaging transport element 33, which, in turn, causes the other transport elements 33 to be displaced too. Advantageously, several transport elements 33 engage the thread 36 simultaneously so as to ensure the safe displacement of the transport elements 33 along the guide path 32. With such a construction, in which several transport elements 33 act on the welding wire 13 at the same time, it is achieved in an advantageous manner that several pressure points are formed on the welding wire 13 so as to ensure the safe feeding of the welding wire 13.

Furthermore, a guide groove 38 is machined into the half-shell 30 of the element 28, via which the element 28 or half-shells 30 can be positioned and guided on the base body 29. At least one guide pin 50 of the base body 29 engages the guide groove 38 to allow the element 28 to be displaced along a central axis 39 extending along the guide groove 38 (cf. FIGS. 19 to 23).

FIG. 9 shows another configuration of the half-shells 30 of the element 28, in which the guide path 32 has been modified in the zone of the operative connection with the welding wire 13 and/or thread 36 to the extent that the transport elements 33 project out of the element 28 or half-shells 30 over a slight length only. Other configurations of the guide path 32 are, of course, possible too. Thus, a wave-shaped configuration is, for instance, possible, which enables the transport elements 33 to be in operative connection, or in connection, with the welding wire 13 and/or thread 36 at predetermined intervals.

The structure of the base body 29 will now be elucidated by way of FIGS. 10 to 13. The base body 29 is, for instance, made of a one-piece body 40 comprising a conical central portion 41 and, on the conically tapering side, a preferably cylindrical projection 42 as well as, on the opposite side of the projection 42, a positioning flange 45. The projection 42 is mounted in the interior of a drive sleeve 43, preferably via a bearing assembly 44, as is apparent from FIGS. 19 to 23. The positioning flange 44, in turn, is preferably designed to be rectangular. This positioning flange 45 is connected with a retention element 46 in a rotationally fast manner. The retention element 46 can, for instance, be formed by a housing part or a fastening element of a device and, in particular, the welding apparatus 1 or welding torch 10, so that the wire feed device 27 can be appropriately fastened upon installation. This is, for instance, schematically illustrated in FIG. 21, where the wire feed device 27 is incorporated in a welding torch housing 10a.

The central portion 41 of the base body 29 further comprises a guide groove 48 to receive the element 28, wherein, with the application of just one element 28, the base body 29 comprises a slide/guide surface for the welding wire 13 on the opposite side of the guide groove 48. In the exemplary embodiment illustrated, three elements 28 are, however, preferably arranged in three independent guide grooves 48 in the conically tapering central portion 41 of the base body 29. The elements 28 are preferably arranged in three guide grooves 48 which are each angularly offset by 1200. Within the guide grooves 48, the elements 28 are preferably arranged to be longitudinally and/or vertically displaceable. To this end, the guide grooves 48 are designed to be longer in the longitudinal direction than elements 28. Hence, it is no longer necessary to provide a slide/guide surface, since the welding wire 13 extends centrically between the elements 28 relatively arranged at 1200 and is centrally positioned and guided by the transport elements 33. The conical central portion 41, moreover, comprises at least another bore 49, in which the above mentioned guide pins 50 can be inserted to position and guide the elements 28 in the base body 29. At least one bore 49 is required for each element 28 or each guide groove 48, respectively, since the guide pin 50 inserted in this bore 49 guides the element 28, in particular cage, while, at the same time, protecting it from falling out during the assemblage of the wire feed device 27. The element 28, thus, comprises a guide groove 48, and the base body 29 comprises at least one guide pin 50 engaging the guide groove 48 of the element 28. Due to the guide groove 48 extending in parallel with the conically designed thread 37 of the drive sleeve 43, the base body 29 and the element 28, the element 28 is displaced parallelly to this conical design within the guide groove 48.

To guide the welding wire 13, a through bore 51 into which the guide grooves 48 open extends through the base body 29 so as to allow the transport elements 33 to act on the welding wire 13 with the element 28 inserted.

The base body 29 with the elements 28 arranged in the base body 29 is preferably centrically arranged in the drive sleeve 43, said drive sleeve 43 forming the drive means 37. A detailed illustration of the drive sleeve 43 is given in FIGS. 14 to 18. In the drive sleeve 43, the thread 36 is arranged, which is designed as a conical internal thread matching the contour of the parts of the wire feed device 27, in particular the element 28 with the transport elements 33, the central portion 41, and which is engaged by at least one transport element 33 arranged in the element 28. The turn of the thread 36 is, thus, adapted to the contour or dimensions or size of the transport element 33. The thread 36, which is designed as an internal thread, extends conically. The conical extension of the individual parts like the thread 36, the central portion 41 and the element 28 preferably comprises an angle 52 of between 50 and 250. The pitch of the thread 36 can, thus, be derived from the size of the transport element 33, yet may also be larger. The conical extension ensures in a simple manner that the individual parts will always be arranged or positioned in a mutually centric fashion so as to enable a highly comfortable assemblage of the individual parts, requiring little time. The transport elements 33 can also be formed by other special shapes such as, for instance, rollers, cylinders, cubes, pyramids, etc.

Opposite the thread 36, a depression 53 is provided to receive the bearing assembly 44 for the projection 42 of the base body 29, as can be taken from, and is elucidated in, subsequent FIGS. 19 to 23. Preferably, three internal threads 56 are arranged in the region of the depression 53 so as to be offset relative to a central axis 54 of the drive sleeve 43 forming the drive means 37 by an angle 55 of, preferably, approximately 1200. These internal threads 56 enable a coupling element 47 to be connected with the drive means 37, for instance, by headless pins (not illustrated).

Moreover, a drive 57, in particular electromotor, is connected with the coupling element 47 or directly with the drive sleeve 43 forming the drive means 37 for the transport element 33. Naturally, it is also possible to arrange a gear between the drive 57 and the coupling element 47. In the exemplary embodiment illustrated, the drive 57 comprises a hollow shaft 58, via which the drive 57 is connected with the coupling element 47 and through which the welding wire 13 can be guided to the wire feed device 27. The drive 57 is arranged axially to the feed direction. Naturally, the drive 57 can also be arranged in parallel with, or beside, the wire feed device 27, the welding wire 13 in those cases being no longer guided through the drive 57. Preferably, the drive 57 is arranged in front of the wire feed device 27, whereby, during the thread-in procedure of the welding wire 13, the latter is initially guided through the drive 57, i.e. the hollow shaft 58, and subsequently threaded into the wire feed device 27. Furthermore, the drive 57, in particular a casing 59 of the drive 57, is connected with a further retention element 60 in a rotationally fast manner so as to enable the drive 57 to carry out a rotational movement via the hollow shaft 58 to the drive sleeve 43, while the casing 59 is rigidly fixed. The drive sleeve 43 is, thus, set in rotation to cause a displacement of the transport elements 33 via the thread 36 and the feeding of the welding wire 13 in the respective direction by the transport elements 33 being in operative connection with the former. Thus, a force or speed is transmitted to the wire feed device 27 via the hollow shaft 58 of the drive 57. The speed of the drive 57 can be adjusted or controlled via a separate control device (not illustrated) or the control device 4 of the welding apparatus 1.

The wire feed device 27 set in rotation by the drive 57 and, in particular, the drive sleeve 43, via the thread 36 of the drive sleeve 43, thus, convey the transport elements 33 arranged to circulate within the element 28 and engaging the thread 36. The transport elements 33 are, thus, moved in a circulating manner within the guide path 32 provided in the element 28. On the side 34 facing the welding wire 13, of the element 28, at least one transport element 33 is in operative connection with the welding wire 13. By the previously described movement of the transport elements 33 and the operative connection between the transport elements 33 and the welding wire 13, the welding wire 13 is transported in the direction of the moved transport elements 33. The welding wire 13 is fed as a function of the direcation of rotation realized by the drive 57. In doing so, both a forward movement and a rearward movement of the welding wire 13 are feasible by merely reversing the direction of rotation of the drive 57.

Furthermore, a pressure element 61 may be provided in the base body 29 to be positioned or arranged between the positioning flange 45 of the base body 29 and the element 28 and exert a pressure force onto the element 28. The pressure element 61 may be comprised of a pressure disc 62 and a compression spring 63. The pressure disc 62 transmits onto the element 28 the force of the compression spring 63, which is arranged to follow the pressure disc 62 in the welding feed direction of the welding wire 13 transported to the welding process. In the interior of the positioning flange 45, a disc 64 may be detachably arranged such that the compression spring 63 is supported on the disc 64 so as to exert a pressure force on the pressure disc 62 and, hence, on the element 28. In order to exchange or replace the compression spring 63, the disc 64 can be detached from the positioning flange 45. Thereby, also an adaptation of the pressure force, for instance in different welding processes, can be effected by changing the compression spring 63. The disc 64 may also be connected with the positioning flange 45 by a thread (not illustrated) so as to enable a change of the pressure force by turning the disc 64. With the disc 64 being further turned in, the compression spring 63 is further compressed so as to exert a higher pressure force on the element 28. With such a configuration, the compression spring 63 need no longer be exchanged in order to obtain different pressure forces, but can be adjusted by simply rotating the disc 64.

By the pressure element 61 arranged between the element 28 and the positioning flange 45, the element 28 is displaced or pressed in the direction of the projection 42 along the guide groove 38. It is thereby ensured that, in the event where no welding wire 13 is inserted in the wire feed device 27, the elements 28 will be displaced until the transport elements 33 of the individual elements 28 arranged opposite the thread 36 will contact each other, whereby a starting position will be defined. During the introduction of the welding wire 13 into the wire feed device 27, the element 28 will then be pressed in the direction of the pressure element 61 by the welding wire 13 so as to cause a divergence of the elements 28, in particular transport elements 33, relative to each other in order to enable the welding wire 13 to enter between the elements 28, thus causing the transport elements 33 to abut on the same. In this manner, an automatic adaptation to the diameter of the welding wire 13 is achieved. The wire feed device 27 according to the invention can, thus, be employed with any welding wire 13 irrespective of the material and thickness or diameter of the welding wire 13, as is to be seen from FIGS. 21 and 22. At the same time, the force action of the transport elements 33 on the welding wire 13 is influenced via the pressure force of the pressure element 61 so as to increase the application pressure exerted by the transport elements 33 on the welding wire 13 at an increased pressure force.

In FIG. 21, a welding wire 13 having a smaller diameter 65 than the welding wire 13 which is used in FIG. 22 and has a larger diameter 66 is employed. It is apparent that the elements 28 are now displaced and pressed apart within the guide groove 48 on account of the different diameters 65, 66 of the welding wires 13.

An essential advantage of the wire feed device 27 according to the invention resides in that the latter comprises a very compact mode of construction, the outer diameter 67 of the wire feed device 27 in a preferred manner being, for instance, between 20 mm and 40 mm. The wire feed device 27 can, thus, be installed in commercially available hand torches 10 and, in particular, in the grip plate of the hand torch 10. Thus, also the wire feed will be substantially improved, with the benefits of a quick-reacting and even reversible wire feed device 27 being also applicable in a hand torch 10. It is, of course, also possible to arrange the wire feed device 27 in a welding apparatus 1 or an external wire feed device, or directly integrate it in a hose pack 23.

Naturally, it is also possible to use just one element 28 instead of the three elements 28 described in the preceding exemplary embodiment, and to provide a guide surface on the side located opposite the element 28 towards the welding wire 13, over which the welding wire 13 runs. The pressure acting on the welding wire 13 from the element 28 and the transport elements 33 arranged therein, thus, causes the welding wire 13 to be pressed against this guide surface and subsequently conveyed by the operative connection between the transport elements 33 and the welding wire 13. The guide surface may be plane or may, for instance, comprise a small indentation or guide groove for the welding wire 13. A simple construction of the wire feed device 27 according to the invention is, thus, again provided.

The wire feed device 27 according to the invention may also be configured in the manner described by way of FIGS. 24 to 28.

The wire feed device 27 in this case comprises a main element 69, a base body 70, at least one element 71 including transport elements 72 arranged to circulate therein, and a drive pulley 73.

The main element 69 on one side has a depression 74, from which a conically tapering bore 75 extends farther into the interior of the main element 69. On the conically tapering side, i.e. on the side opposite the depression 74, a further opening 76 is provided, which is preferably rectangular and in which the base body 70 is arranged in a rotationally fast manner. In this exemplary embodiment, the drive pulley 73 is rotationally mounted in the depression 74.

The base body 70 arranged in the interior of the main element 69 is connected with the main element 69 in a rotationally fast manner. The base body 70 is comprised of a conically designed main portion 70a and a projection 70b arranged on the conically tapering side of the main part 70a, which projection is preferably designed to be rectangular in order to arrange the base body 70 in the main element 69 in a rotationally fast manner. The fixation of the base body 70 in the main element 69 can, for instance, be realized by a headless pin arranged in the main element 69 in a bore provided normally to the central axis of the main element 69.

It is, of course, also possible to arrange the base body 70 in the main element 69 in any other manner. It is, for instance, possible to arrange a shaft on the base body 70, on the conically tapering side of the main portion 70a, to position the base body 70 via this shaft in the main element 69, the base body 70 in this case being screw-connected with the main element in a rotationally fast manner.

The drive pulley 73 arranged in the depression 74 of the main element 70 is connected with a motor, in particular a drive 77. The drive 77 can be formed by any motor known from the prior art. The drive 77 comprises a hollow shaft 78 extending through the drive 77 in the wire feed direction. The hollow shaft 78 serves to connect the drive 77 with the drive pulley 73. To this end, the base body 70 and a projection 70b are formed in correspondence with the hollow shaft 79 in order to guide the welding wire 13 therethrough centrally of the wire feed device 27 and the drive 77. The element 71 is arranged in the interior of the main element 69, i.e. in the conically tapering bore 75 of the main element 69, and in a longitudinal groove 79 of the base body 70. The element 71 is comprised of two half-shells 80, in which a guide path 81 is machined to arranged therein the transport elements 72 in a circulating manner. At least one transport element 72 engages the drive pulley 73. The drive pulley 73 drives the transport elements 72 by the aid of a flight 82 which is spirally machined, e.g. milled, into the drive pulley 73, departing from the center of the drive pulley 73 (cf. FIG. 28), and moves the transport elements 72 along the guide path 81. The guide path 81 of the element 71 provided for the transport elements 72 on at least two sides of the element 71 is partially arranged outside the element 71 such that the transport elements 72 partially project out of the element 71 on theses sides. Thus, at least one transport element 72 engages the flight 82 of the drive pulley 73 on a side of the element 71 facing the drive pulley 73 and at least one transport element 72 is in operative connection with the welding wire 13 on a side facing the welding wire 13. By turning the drive pulley 73, the transport element 72 engaging the flight 82 is then moved along the guide path 81 by the flight 82. Thus, all the transport elements 72 are moved along the guide path 81, and the welding wire 13 is fed through the transport element(s) 72 in operative connection with the welding wire 13, because of the former exerting a contact pressure on the welding wire 13 and the welding wire 13 being moved along by the friction generated during the displacement of all transport elements 72.

This configuration of the wire feed device 27 according to the invention allows the dimensions of the wire feed device 27 to be kept very small, since, due to the hollow shaft 78 of the drive 77, the welding wire 13 is fed through the drive 77 and the drive 77 is arranged in the same axis as the wire feed device 27. Naturally, it is also possible to arrange the drive 77 in a laterally offset manner, in which case the force or moment of the drive 77 can then be transmitted to the wire feed device 27, for instance, via toothed wheels or a V-belt, whereby, however, the wire feed device 27 can no longer be easily incorporated in a hand torch 10, yet still be readily installed in the welding apparatus 1 or outside the welding plant.

In order to effect an adjustment to the actually used welding wire 13 in the case of different welding wire diameters, the drive 77 is arranged in a retention element 83 in a rotationally fast manner (cf. FIGS. 26 and 27). The rotationally fast arrangement may, in turn, be realized in various ways, for instance by a preferably rectangular design of an opening 84 provided in the retention element 83 for the insertion of the drive 77. The retention element 83, which is schematically illustrated, can be formed by a fastening plate or fastening clamps or ribs of a housing of the welding torch 10 or the welding apparatus 1. In the preferably rectangular opening 84, a spring 84 may be arranged between the drive 77 and the end of the opening 84, which spring causes the wire feed device 27 to automatically adjust to the inserted welding wire 13 so as to not require any alterations or adjustments at the wire feed device 27 by the user if a different welding wire 13 having a different diameter is used. When inserting the welding wire 13, the elements 71, due to the conical configuration of the wire feed device 27, are pressed or moved away from the welding wire 13 and, further, in the direction of the drive 77. A pressure is, thus, exerted by the spring 85 onto the drive pulley 73 and, hence, onto the elements 71 so as to cause the latter, again due to the conical configuration of the wire feed device 27, to transmit the pressure further onto the welding wire 13 so as to cause the latter to be conveyed on account of the operative connection between the welding wire 13 and the transport elements 72 arranged in the element 71. The drive 77 can also be rigidly fastened to a housing or the retention elements 83 without any spring 85 or pressure element, yet while resiliently fastening the wire feed device 27, i.e., the main element 69 so as to cause the latter to be pressed in the direction of the drive 77. In this case, the spring 85, or any other pressure element, acts on the end face opposite the drive 77, of the wire feed device 27, thus causing the elements 71 to be pressed against the drive pulley 73 along with the transport elements 72. This again ensures the safe engagement of the drive elements 72 in the flight 82 while, at the same time, enabling the elements 71 to automatically adapt to the different diameters of the welding wires 13. The fastening or bearing site of the wire feed device 27 is not illustrated in this exemplary embodiment. It may again be realized in a simple manner in that the wire feed device 27 is screwed to an accordingly designed retention element 83 or a housing part or fastening ribs.

In FIGS. 29 and 30, a further exemplary embodiment of the wire feed device 27 according to the invention is described and schematically illustrated.

FIGS. 29 and 30 depict an assembly of the wire feed device 27 according to the invention, wherein, in this exemplary embodiment, just one element 71a is movably arranged relative to the welding wire 13 in the base body 70, while two other elements 71 are rigidly positioned in the base body 70. In the elements, 71, 71a, circulating transport elements 72 are arranged, which act on the welding wire 13 on one side of the element 71 and engage a thread 69a of the main element 69 on the opposite side. In this case, only the transport elements 72 of the rigidly arranged elements 71 engage the thread 69a, or flight of the thread 69a. The third element 71a is movably arranged and pressed with the required pressure in the direction of the welding wire 13 by a pressure element 69b formed, for instance, by a pressure spring or a pressure hose 69c capable of being actuated, e.g., by compressed air. Thus, an embodiment is provided, which is substantially simplified over the previously described wire feed devices 27. Naturally, liquids or gases or similar beneficial media may also be used in the pressure hose 69c.

With this configuration of the wire feed device 27 according to the invention, it is essential that only one element 71a exerts a pressure on the welding wire 13 and, hence, is in operative connection with the same, while two other elements 71 are rigidly arranged in the base body 70, feeding the welding wire 13 merely by the transport elements 72 engaging the thread 69a of the main element 69 and the operative connection between the welding wire 13 and the transport elements 72. Consequently, with, for instance, different welding wire diameters, the welding wire 13 need only be displaces in the direction of the center of the wire feed device 27, thus causing the welding wire 13 to run eccentrically in the wire feed device 27, which will, however, in no way affect the welding process. Naturally, it is also possible that one element 71 is rigidly arranged and two elements 71a are arranged to be movable towards the welding wire 13.

FIG. 31 depicts a further exemplary embodiment, in which a reversing movement of the welding wire 13 is provided without reversal of the direction of the drive 77. In this case, the wire feed device 27 is to be movably arranged axially to the wire feed device 27. This may, for instance, be realized by arranging the wire feed device 27 on a guide rail 86. The wire feed device 27 as well as the drive 77 in this case are movably arranged on the guide rail 86. The guide rail 86 can be designed as a dovetail guide, with the wire feed device 27 and the drive 77 being mounted on the guide rail 86 via specially designed retention elements 86a so as to enable a longitudinal displacement of the whole unit. It is thereby feasible to install individual parts like the wire feed device 27 and the drive 77 in a supporting frame 86b. The supporting frame 86b is mounted on the guide rail 86 so as to be adjustable in the longitudinal direction. Hence, the welding wire 13 is transported by the wire feed device 27 in only one direction corresponding to arrow 87, while the overall unit, i.e. the supporting frame 86b with the wire feed device 27 and the drive 77, at the respectively required instances will perform movements in the opposite direction and back again—arrow 88—such that, during the rearward transport of the supporting frame 86b, the welding wire 13 will be moved away from the workpiece 16 even at a welding wire feed from the wire feed device 27 in the direction to the workpiece 16. This can, for instance, be controlled by a control device controlling a motor or drive, yet the described control device and drive are not illustrated. Such a structure including a supporting frame 86b may, of course, be used in all of the exemplary embodiments described, so that a module harbouring all parts will be provided. This will ensure simple mounting of the wire feed unit or wire feed device 27, as only the supporting frame 86b remains to be fastened to a mounting plate or housing in the welding apparatus 1 or welding torch 10. After this, only cabling will have to be installed. A simple exchange of the whole module is thereby feasible.

A further configuration of the wire feed device 27 according to the invention is illustrated in FIGS. 32 and 33. The welding wire 13 is again fed by the transport elements 72 in operative connection with the welding wire 13. The transport elements 72 are arranged to circulate in the element 71 and, on a side facing the drive pulley 73, engage the flight 82 of the drive pulley 73, which in this exemplary embodiment is again designed as a guide coil.

The element 71 is arranged in a guide groove 89 so as to be displaceable in the direction of the welding wire 13, i.e. normally to the welding wire 13. Between the element 71 and a cover 90, a pressure spring 91 may be arranged to press the element 71 in the direction of the welding wire 13. With the welding wire 13 not inserted, the elements 71 are, hence, displaced relative to each other such that the transport elements 72 arranged to circulate in the elements 71 will contact each other. As the welding wire is threaded in, the elements 71 are being pushed apart by the welding wire 13. On account of the pressure spring 91 arranged in the main element 69 between the cover 90 and the element 71, the elements 71 are pressed onto the welding wire 13 by a predefined pressure force. The automatic adaptation or adjustment of the wire feed device 27 to the respectively inserted welding wire 13 is, thus, ensured in a simple manner. Moreover, no conversion work will be required for a welding wire exchange.

This exemplary embodiment offers the advantage of the wire feed device 27 being comprised of few parts. As opposed to the previously described variant embodiments, no base body 29 or 70 is required in this exemplary embodiment.

Another variant embodiment of the wire feed device 27 according to the invention is illustrated in FIGS. 34 and 35, wherein the drive pulley 73 is conically designed and, hence, comprises a conically extending thread 92 which is engaged by the transport elements 72 of the element 71. The element 71 is movably arranged in the main element 69 via the guide groove 89. Along a further guide groove 93, which is provided in the element 71 and engaged, for instance, by fixing pins of the main element 69, the element 71 is adjusted or displaced.

Furthermore, a pressure element 94 is arranged in the main element 69 between the element 71 and a pressure disc 95 to exert a pressure force on the element 71 and, hence, enable automatic adjustment to the respectively inserted welding wire 13.

In addition, it should be mentioned that the drive pulley 73 is connected with the hollow shaft 78 of the drive 77 and, hence, only the drive pulley 73 is rotationally mounted in the main element 69. As a result, only the element 71 and the drive pulley 73 are subject to little wear such that the service life of the wire feed device 27 according to the invention is substantially increased over other embodiments and, if the drive pulley 73 or the element 71 is worn, a simple exchange will, moreover, be feasible.

The drive 77 as well as the main element 69 are, for instance, arranged in a hand torch in a rotationally fast manner. It is, or course, not necessarily required to arrange the wire feed device 27 according to the invention in a hand torch, this may also be done in a welding apparatus 1, in the hose pack 23 or outside the welding plant.

In order to ensure the automatic adjustment or setting to the respectively employed welding wire 13, it is also possible to arrange the transport elements 72 in at least one element 71 which is, for instance, designed as an eccentric, as is schematically illustrated in FIGS. 36 and 37.

The transport elements 72 are again arranged to circulate in the element 71, with the transport elements 72 partially projecting out of the element 71 in this exemplary embodiment. In this exemplary embodiment, the element 71 is designed to be oval and eccentrically mounted in the main element 69 by the aid of a fixing pin, which means that, with the welding wire 13 not inserted, the transport elements 71 facing the welding wire 13 contact each other. As a welding wire 13 is inserted, the elements 71 are being pressed apart by the welding wire 13, with the center of motion being located in the center of the fixing pin. By the aid of a pressure element 96, the eccentrically mounted element 71 is pressed in the direction of the welding wire 13, thus causing the wire feed device 27 to again effect an automatic adjustment to the respectively employed welding wire 13. The pressure element 96 is movably mounted in the base body 70 and is pressed in the direction of the element 71 by a pressure spring 97 arranged between the base body 70 and the pressure element 96.

FIGS. 38 and 39 schematically depict a further exemplary embodiment of the wire feed device 27 according to the invention, with two wire feed devices 27 being consecutively arranged in the wire feed direction and a common drive 77 being arranged in a manner laterally offset relative to the wire feed devices 27.

In this configuration, it is essential that the drive 77 is arranged in parallel with the wire feed devices 27 in a laterally offset manner and the wire feed devices 27 are driven by the drive 77, e.g., via a toothed belt, a V-belt or a toothed wheel 98. The drive 77 comprises a shaft 99 on either side of the drive 77, wherein a toothed wheel 98 is each arranged on the shaft 99 to be in operative connection with the wire feed device 27, this being, for instance, effected via a toothing provided about the periphery of the wire feed device 27.

It is thereby ensured in a simple manner that, on account of two consecutively arranged wire feed devices 27, twice as many transport elements 72 will press on the welding wire 13 and, hence, enable an even better and safer transport of the welding wire 13.

In FIG. 39, the drive 77 is again arranged in parallel with the wire feed devices 27 in a laterally offset manner, yet the drive 77 comprises just one shaft 99, on which two toothed wheels 98 are arranged to drive the wire feed devices 27.

Naturally, it is also possible to arrange the drive 77 normally to the wire feed device 27, with the moment being deflected and transmitted onto the wire feed device 27, for instance, merely via helical gear wheels 98.

The following FIGS. 40 to 42 schematically illustrate various exemplary embodiments of the wire feed device 27 according to the invention for different types of welding wires 13. The illustrations correspond to a schematically represented detail of the welding wire 13 with the elements 71 arranged about the welding wire 13 as well as the transport elements 72 arranged to circulate in elements 71.

FIG. 40 shows an application for a welding wire 13 designed as a flat wire, wherein at least two elements 71 with the transport elements 72 arranged to circulate therein are arranged on either of the flat sides of the welding wire 13 in opposed relationship.

Naturally, also four elements 71 can be provided as depicted in FIG. 41. The only disadvantage here is that only a force adapted to the welding wire 13 is allowed to act on the welding wire 13 from the elements 71 arranged on the narrow sides of the welding wire 13, since otherwise the welding wire 13 would be deformed.

In FIG. 42, a welding wire 13 having a triangular cross section is schematically illustrated. One element 71 is each arranged on each side of the welding wire 13, preferably normally to the respective side of the welding wire 13.

A spherical configuration of the transport elements 33, 72 is not necessarily required for the wire feed, yet it constitutes the simplest way of realizing transport elements 33, 72 with the lowest friction.

In FIG. 43, a transport element 33, 72 having, for instance, an elongate-oval shape is schematically illustrated. The element 28, 71 is again comprised of two half-shells 30, 80, with the transport elements 33, 72 being arranged in a peripheral guide groove 38 or guide path 81. Naturally, the transport element 33, 72 may be designed in various ways to ensure the transport or feed of the welding wire 13.

In order to enable the measurement or determination of the wire feed speed, means for measuring the number of revolutions of the wire feed device 27 can be arranged on the end face of the wire feed device 27. This may, for instance, be realized via optical sensors just comprising a light/dark recognition and detecting the respective number of revolutions via appropriate marks provided on the end face of the wire feed device 27. From the number of revolutions, the wire feed speed can then be calculated by a known calculation formula.

Finally, it remains to be added that the number of elements 28, 71 used for the wire feed is limited, since the outer diameter of the welding wire 13 is only between 0.7 mm and 3.2 mm and, therefore, the size of the transport elements 33, 72 will have to be altered if several elements 28, 71 with the transport elements 33, 72 arranged therein are to find a place around the inserted welding wire 13. Thus, for instance, in the event of five elements 28, 71 arranged around the welding wire 13 having a circular cross section, the transport elements 33, 72 would contact one another before entering into contact with the welding wire 13, so that no operative connection would be established between the transport elements 33, 72 and the welding wire 13.

1-40. (canceled)

41. A wire feed device for transporting a welding wire (13) from a wire storage to a point of consumption, including at least one element (28) for guiding the welding wire (13), wherein at least one guiding element (28) including a guide path (32) is provided, along which several transport elements (33) are displaceably mounted, wherein furthermore at least one transport element (33) is connected with a drive means (37) and at least one further transport element (33) is connected with the welding wire (13) in a force-locking and/or form-locking manner, wherein at least one guiding element (28) is displaceably arranged for adaptation to the diameter of the welding wire (13).

42. A wire feed device according to claim 41, wherein at least one guiding element (28) is displaceably arranged in a base body (29).

43. A wire feed device according to claim 41, wherein several guiding elements (28) are provided.

44. A wire feed device according to claim 43, wherein three guiding elements (28), which are preferably offset by an angle of 1200, are arranged about the welding wire (13).

45. A wire feed device according to claim 42, wherein the base body (29) together with said at least one guiding element (28) is, preferably centrically, arranged in a drive sleeve (43), with the drive means (37) being formed by this drive sleeve (43).

46. A wire feed device according to claim 45, wherein the drive sleeve (43) is formed with an internal thread adapted to the contour of the transport element (33) and engaged by at least on transport element (33).

47. A wire feed device according to claim 46, wherein the internal thread of the drive sleeve (43), the base body (29) and the guiding element (28) are preferably conically designed.

48. A wire feed device according to claim 46, wherein the base body (29) comprises a preferably cylindrical projection (42), which is mounted in the interior of the drive sleeve (43), preferably via a bearing assembly (44).

49. A wire feed device according to claim 48, wherein the base body (29), on its side located opposite the projection (42), comprises a preferably rectangularly designed positioning flange (45).

50. A wire feed device according to claim 49, the positioning flange (45) is connected with a retention element (46) in a rotationally fast manner.

51. A wire feed device according to claim 50, wherein the drive sleeve (43) is connected with a coupling element (47), said coupling element (47) being arranged on the opposite side of the retention element (46).

52. A wire feed device according to claim 51, wherein the coupling element (47) or the drive sleeve (43) is directly connected with a drive (57), in particular electromotor.

53. A wire feed device according to claim 52, wherein the drive (57) is arranged axially to the wire feed device (27).

54. A wire feed device according to claim 53, wherein the drive (57) comprises a hollow shaft (58), which is connected with the coupling element (47) and through which the welding wire (13) is passable to the wire feed device (27).

55. A wire feed device according to claim 52, wherein the drive (57), in particular a casing (59) of the drive (57), is connected with a further retention element (60) in a rotationally fast manner.

56. A wire feed device according to claim 42, wherein a pressure element (61) is arranged in the base body (29) so as to be positioned between the positioning flange (45) and the guiding element (28) and exert a pressure force onto the guiding element (28).

57. A wire feed device according to claim 42, wherein the guiding element (28) comprises a guide groove (38) and at least one guide pin (50) is arranged on the base body (29) to engage said guide groove (38) of the guiding element (28).

58. A wire feed device according to claim 41, wherein the transport element (33) is designed in the form of a ball.

59. A wire feed device according to claim 45, wherein the drive sleeve (43) has an outer diameter (67) of between 20 mm and 30 mm.

60. A wire feed device according to claim 41, wherein the wire feed device (27) is arranged in a welding torch (10) and/or welding apparatus (1).

61. A method for feeding a welding wire (13) from a wire storage to a point of consumption, wherein the welding wire (13) is guided through at least one element (28), and wherein several transport elements (33) are guided in at least one guiding element (28) to circulate along a guide path (32), with at least one transport element (33) being in operative connection with the welding wire (13) on a side of the guiding element (28) facing the welding wire (13), and on at least one further side of the guiding element (28), at least one further transport element (33) is displaced by a drive means (37), thus causing the further transport elements (33) arranged in the guide path (32) to be moved on by said one transport element (33) displaced by the drive means (37), wherein at least one guiding element (28) is displaced for adaptation to the diameter of the welding wire (13).

62. A feeding method according to claim 61, wherein the guiding element (28) is displaced in a base body (29), preferably in the longitudinal and/or vertical direction.

63. A feeding method according to claim 62, wherein several guiding elements (28) are arranged in the base body (29).

64. A feeding method according to claim 62, wherein preferably three guiding elements (28), which are offset by 120°, are arranged in the base body (29).

65. A feeding method according to claim 62, wherein the base body (29), together with the guiding element (28) arranged therein, is preferably centrically arranged in a drive sleeve (43) forming the drive means (37).

66. A feeding method according to claim 65, wherein at least one transport element (33) engages a thread (36) of the drive means (37), with the contour of the thread (36) being adapted to the contour of the transport element (33).

67. A feeding method according to claim 66, wherein the thread (36) of the drive sleeve (43), the base body (29) and the guiding element (28) are preferably conically designed.

68. A feeding method according to claim 66, wherein the base body (29) comprises a preferably cylindrical projection (42), via which the base body (29) is mounted in the interior of the drive sleeve (43), preferably via a bearing assembly (44).

69. A feeding method according to claim 68, wherein the base body (29), on its side located opposite the projection (42), comprises a preferably rectangularly designed positioning flange (45).

70. A feeding method according to claim 69, wherein the positioning flange (45) is connected with a retention element (46) in a rotationally fast manner.

71. A feeding method according to claim 70, wherein a coupling element (47) is connected with the drive sleeve (43) on the opposite side of the retention element (46).

72. A feeding method according to claim 71, wherein the coupling element (47) or the drive sleeve (43) is directly connected with a drive (57), in particular electromotor.

73. A feeding method according to claim 72, wherein the drive (57) is arranged axially to the wire feed device.

74. A feeding method according to claim 73, wherein the drive (57) is connected with the coupling element (47) via a hollow shaft (58) arranged in the drive (57), said welding wire (13) being fed through said hollow shaft (58).

75. A feeding method according to claim 72, wherein the drive (57), in particular a casing (59) of the drive (57), is connected with a further retention element (60) in a rotationally fast manner.

76. A feeding method according to claim 62, wherein a pressure force is exerted on the guiding element (28) by a pressure element (61) arranged in the base body (29) between the positioning flange (45) and the guiding element (28).

77. A feeding method according to claim 62, wherein at least one guide pin (50) arranged on the base body (29) engages a guide groove (38) of the guiding element (28) and the guiding element (28) is displaced via said assembly.

78. A feeding method according to claim 61, wherein the transport element (33) is designed in the form of a ball.

79. A feeding method according to claim 65, wherein the drive sleeve (43) has an outer diameter (67) preferably of between 20 mm and 30 mm.

80. A feeding method according to claim 61, wherein the wire feed device (27) is preferably arranged in a welding torch (10) and/or welding apparatus (1).
